(19) United States
(12) Patent Application Publication
(10) Pub. No.: US 2020/0170265 A1
(43) Pub. Date: Jun. 4, 2020

(54) COMBINED NATURAL GUT/RECONSTITUTED COLLAGEN CASING AND METHOD FOR MAKING CASING

(71) Applicant: Nitta Casings Inc., Bridgewater, NJ (US)

(72) Inventors: Eugene Goldfarb, Marlboro, NJ (US); Masayuki Mimasu, Nara (JP); David Mathews, Somerville, NJ (US)

(21) Appl. No.: 16/205,460

(22) Filed: Nov. 30, 2018

(51) Int. Cl. A22C 13/00; A22C 17/14

(52) U.S. Cl. CPC A22C 13/0026; A22C 17/14; A22C 2013/0096; A22C 2013/005; A22C 2013/002

(57) ABSTRACT

Edible tubular casings for meats, such as sausages are described. The casings are comprised of reconstituted collagen combined with natural casing material comprising bovine, porcine or sheep gut, or combinations thereof. Methods for producing the casings by forming a gel consisting of a combination of the natural material and the reconstituted collagen are also described.

The present invention is directed, in one aspect, to tubular casings for meats, such as sausages. The casings are comprised of natural casing material comprising bovine, porcine or sheep gut tissue, combined with reconstituted collagen. In another aspect, the present invention is directed to methods of producing casings comprising a combination of natural gut tissue and reconstituted collagen.

### BACKGROUND OF THE INVENTION

Reconstituted collagen is used in the manufacture of tubular casings for meats, such as sausages. The collagen used in these casings may be obtained, for example, from the corium layer of bovine hides. The collagen raw material is comminuted and mixed with a swelling agent to produce a uniform dispersion from which a continuous tube is formed. The tube is then neutralized by the injection of gaseous ammonia or by contact with a liquid salt solution. The casing is washed in water to remove neutralization salts, plasticized by passing it through successive liquid baths and dried while inflated. Examples of such processes are disclosed in U.S. Pat. Nos. 3,535,125, 3,821,439, 4,388,331, and 5,820,812, the entire contents of each of which are hereby incorporated by reference.

Natural casing material from bovine, porcine or sheep gut can also be used to produce sausages. It would be desirable to have a tubular casing comprised of a combination of reconstituted collagen and natural casing material to provide a tubular casing having improved properties for use in meat products such as sausages.

### SUMMARY OF THE INVENTION

An edible tubular casing for meat products comprises reconstituted collagen combined with natural casing material comprising bovine, porcine or sheep gut, or combinations thereof. The tubular casing may comprise between about 1 wt % to about 10 wt % natural casing (dry basis). In some embodiments, the edible collagen casing comprises between about 1 wt % to about 7 wt % natural casing (dry basis). In one embodiment, the edible collagen casing comprises between about 2 wt % to about 5 wt % of natural casing (dry basis). In another embodiment, the edible collagen casing may comprise between about 5 wt % to about 10 wt % of natural casing (dry basis). The invention is not limited in this regard, and the collagen casing may contain any desired amount of natural casing material in combination with reconstituted collagen to form the collagen casing.

Reconstituted collagen for a tubular casing is produced by processing the corium layer of animal hides. The corium layer is separated from the grain layer of the animal hide on a leather splitting machine. In one embodiment, the corium layer is treated with an ammonium sulfate solution, water washed, and further treated with citric acid/sodium citrate solution followed by a water wash. The treated corium layer is shredded and ground to reduce the particle size of the corium material. In one embodiment, the corium material is ground to a quarter grind having a particle size of about one-quarter of an inch.

The ground corium material is dispersed in water and shredded to form a hydrated mass. The shredded corium material is blended with a dispersion of acid and cellulose. After blending, the mixture of shredded corium material and the acid-cellulose dispersion are stored in an aging tank where the ground corium material is converted into a collagen gel. After conversion of the ground corium material to collagen gel in the aging tank, the collagen gel is pumped from the aging tank, homogenized, and stored in a storage tank.

In one embodiment, the natural gut material is combined with the shredded corium material and acid/cellulose dispersion. The natural gut material is ground to reduce the size of the material. In one embodiment, the natural gut material is ground to a size of about ¼ inch. The ground natural gut material is then washed with running water for a sufficient time to clean the gut material. In one embodiment, the ground natural gut material is washed with running water for between about 12 hours to about 24 hours. In another embodiment, the ground natural gut material is washed with running water for at least about 17 hours. After washing, the natural gut material is blended with the shredded corium material and acid/cellulose dispersion and stored in an aging tank to form a gel.

In another embodiment, the natural gut material is treated to form a gel, and the natural gut material gel is blended with the homogenized collagen gel. In this embodiment, the natural gut material is ground to produce a quarter grind material. The ground natural gut material is then washed with running water for a sufficient time to clean the gut material. In one embodiment, the ground natural gut material is washed with running water for between about 12 hours to about 24 hours. In another embodiment, the ground natural gut material is washed with running water for at least about 17 hours. The washed natural gut material is then further ground to about ⅛ inch and microcut at a gap of between about 0.03 inches to about 0.55 inches. The microcut natural gut material is mixed with a hydrochloric acid solution to produce a natural gut material gel. In one embodiment, the hydrochloric acid concentration in the solution is between about 0.2 wt % to about 0.25 wt %. In one embodiment, the natural gut material is treated in hydrochloric acid for at least twelve hours. The treated natural gut material is then blended with collagen gel and stored in a storage tank.

The combined natural gut material gel and collagen gel is extruded to form a casing. In one embodiment, the collagen gel is pumped from the storage tank and filtered prior to extrusion. Following extrusion, the casing is treated to neutralize the acid and coagulate the casing.

After neutralization, the casing is washed and sent through a plasticizer solution. The casing is dried, and then sent through one or more humidification chambers. The finished casing is shirred.

Casings produced by the methods described herein may have one or more enhanced properties such as improved strength, elasticity, stuffing and cooking performance. The natural gut/collagen casing allows a reduction in the amount of cellulose in the collagen gel while sustaining good cooking properties of the casing. The reduction of cellulose also improves clarity and smoothness of the casing. Other advantages of the casing and methods for producing the casings will be apparent to one skilled in the art based upon the description of embodiments of the invention provided below.

### DESCRIPTION OF THE DRAWINGS

FIG. 1 is a schematic showing one embodiment of a process by which an edible casing is produced.

FIG. 2 is a schematic showing two alternate embodiments of the process for combining natural gut material with reconstituted collagen to produce an edible casing.

### DESCRIPTION OF EMBODIMENTS OF THE INVENTION

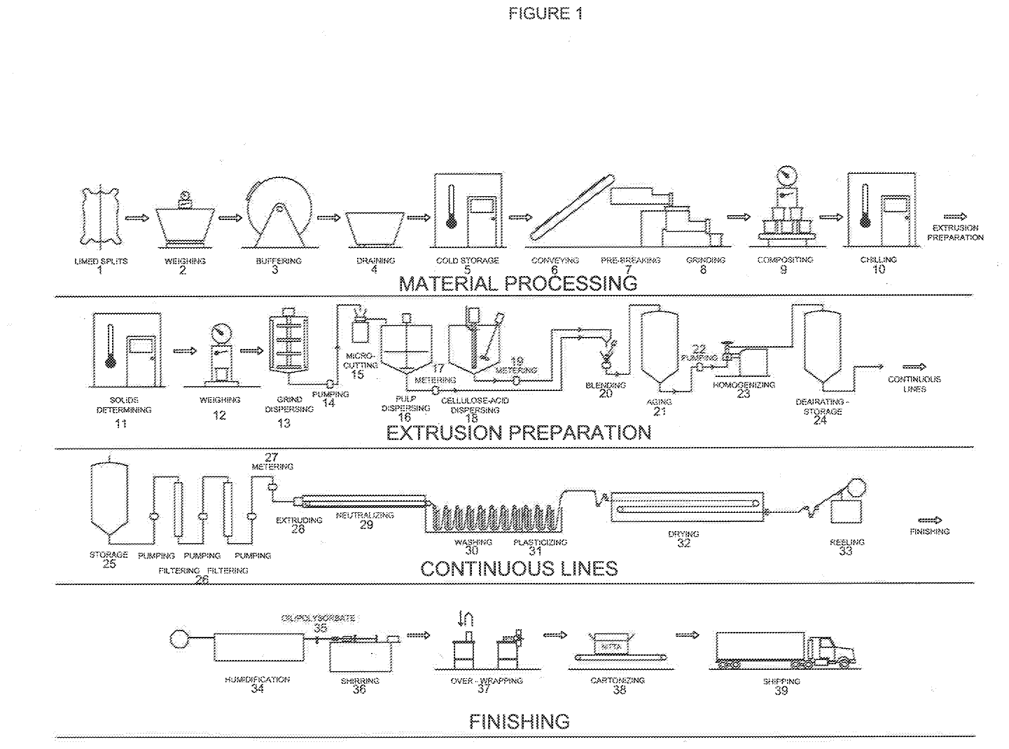

Conventional processes for producing edible collagen casings are known and have been described, for example, in U.S. Pat. No. 5,820,812, the entire contents of which are hereby incorporated by reference. The steps and equipment used in one embodiment of one process is shown schematically in FIG. 1.

In one process for producing tubular casings from reconstituted collagen, animal hides from freshly slaughtered animals are de-fleshed, washed with water, and treated with lime to remove hair. The lime treated animal hides are split on a leather splitting machine to separate the grain layer from the corium layer, which is used to produce the collagen casings. Referring to FIG. 1, the limed corium layers 1 are stored in a refrigerated storeroom that is maintained at 0-4° C. until further processed as described below.

In the embodiment of the process shown in FIG. 1, the corium layers are first processed to prepare the corium material for extrusion into casings. The corium layers are weighed 2 and treated in a buffering drum 3, which is capable of handling up to 3000 Kg of product. In the buffering drum, the corium layers are treated with an ammonium sulfate solution, then water washed. In one embodiment, the ammonium sulfate concentration is in the range of about 0.5%-2.2% (w/w). The corium layers are then further treated with a citric acid/sodium citrate solution followed by another water wash. In one embodiment, the citric acid/sodium citrate concentration is in the range of about 0.0725-0.29% (w/w). The buffering process brings the pH of the corium layer down to approximately 4.3 to 4.9. Assays are run to ensure the product reaches the appropriate pH. The buffered corium layers are drained 4 and the buffered corium layers are placed in cold storage 5 until needed for further processing.

When additional material is needed for processing, the corium layers are sent on a conveyor 6 to be shredded 7 and ground 8 into a quarter grind (i.e., a corium material having a particle size of about one-quarter inch) at less than approximately 25° C. The quarter grind corium material is composited 9 and chilled 10 and maintained at a temperature of about 18° C.

The chilled quarter grind corium material is piped to the extrusion preparation line. The solids are measured 11 and weighed 12 and the quarter grind corium material is dispersed in water 13. The dispersed quarter grind corium material is pumped 14 to a high speed cutting mill 15 where the corium material is further shredded to form a hydrated mass. The hydrated mass is stored and kept mixed in a pulp dispersion tank 16. In a separate blending tank 18, a dispersion of cellulose, HCl and water at 0 to 10° C. is prepared. The dispersion may be prepared, for example, at 5° C.

A quantity of the hydrated quarter grind corium material from the pulp dispersion tank 16 is metered 17 into a blender 20. At the same time, a quantity of the cellulose-acid dispersion from blending tank 18 is metered 19 into the blender 20 and blended with the hydrated quarter grind corium materials to form a gel product.

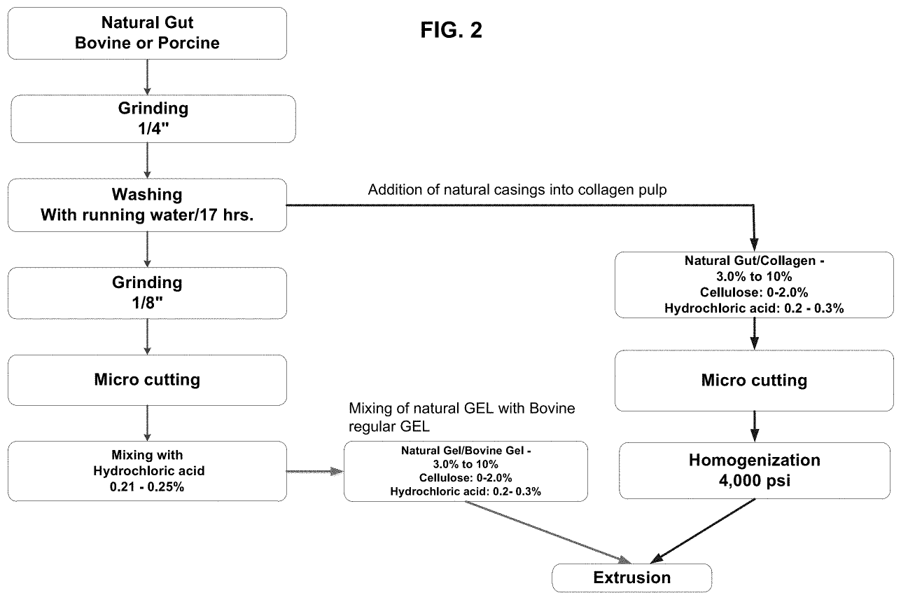

In one embodiment, as illustrated in FIG. 2, natural gut material is blended with the hydrated corium quarter grind and cellulose-acid dispersion. The natural gut material may be bovine, porcine or sheep gut, or combinations thereof. The natural gut material is ground to a desired size prior to blending. In one embodiment, the natural gut material is ground to an average size of about ¼ inch. The ground natural gut material is then washed with running water for a sufficient time to clean the gut material. In one embodiment, the ground natural gut material is washed with running water for between about 12 hours to about 24 hours. In another embodiment, the ground natural gut material is washed with running water for at least about 17 hours. The washed natural gut material is then blended with the hydrated corium quarter grind and the cellulose-acid dispersion. The blended product has the following approximate composition:

| Ingredient | Weight Percent |
|---|---|
| Combined Corium/Natural Gut | About 3 wt % to about 10 wt % |
| Material | |
| Cellulose | 0 wt % to about 2 wt % |
| Hydrochloric acid | About 0.2 wt % to about 0.3 wt % |
| Water | Balance |

The combination of corium and natural gut material is comprised of about 1% to about 10% by weight of the natural gut material and between about 90% to about 99% of the corium quarter grind. In some embodiments, the combination of corium and natural gut material is comprised of about 1% to about 7% by weight of the natural gut material and between about 93% to about 99% of the corium quarter grind. In one embodiment, the combination of corium and natural gut material is comprised of about 2% to about 5% by weight of the natural gut material and between about 95% to about 98% of the corium quarter grind. In another embodiment, The combination of corium and natural gut material is comprised of about 5% to about 10% by weight of the natural gut material and between about 90% to about 95% of the corium quarter grind. The invention is not limited in this regard, and the combination of corium and natural gut material may be comprised of any desired ratio of the two.

After an initial blend period of about 15 to 60 minutes, the gel product is stored in an aging tank 21 for about 20 hours under vacuum. The temperature of the aging tank is maintained at less than 20° C. The gel product is then pumped 22 to a homogenizer 23. After the collagen gel is homogenized, it is sent to a deaeration/storage tank 24 where it is deaerated under vacuum.

In another embodiment of the invention, the natural gut material is treated to form a gel and the natural gut gel is mixed with the corium gel. In this embodiment, the natural gut material is ground to a desired size prior to blending. In one embodiment, the natural gut material is ground to an average size of about ¼ inch. The ground natural gut material is then washed with running water for a sufficient time to clean the gut material. In one embodiment, the ground natural gut material is washed with running water for between about 12 hours to about 24 hours. In another embodiment, the natural gut material is washed with running water for at least about 17 hours.

After washing, the natural gut material is further ground and microcut at a gap of between about 0.03 inches to about 0.55 inches. The natural gut material is mixed with a hydrochloric acid solution to produce a gel. In one embodiment, the hydrochloric acid solution comprises between about 0.2% to about 0.3% by weight hydrochloric acid. In one embodiment, the concentration of hydrochloric acid is between about 0.21% to about 0.25%. In one embodiment, the natural gut material is treated in hydrochloric acid for at least twelve hours. The natural casing material gel is then mixed with the gel formed from the corium and stored in a storage tank 25 maintained at a temperature of about 25° C. The combination of corium and natural gut material is comprised of about 1% to about 10% by weight of the natural gut material and between about 90% to about 99% of the corium quarter grind. In some embodiments, the combination of corium and natural gut material is comprised of about 1% to about 7% by weight of the natural gut material and between about 93% to about 99% of the corium quarter grind. In one embodiment, the combination of corium and natural gut material is comprised of about 2% to about 5% by weight of the natural gut material and between about 95% to about 98% of the corium quarter grind. In another embodiment, The combination of corium and natural gut material is comprised of about 5% to about 10% by weight of the natural gut material and between about 90% to about 95% of the corium quarter grind. The invention is not limited in this regard, and the combination of corium and natural gut material may be comprised of any desired ratio of the two.

In order to form the tubular casing, the combined natural gut and corium gel product is pumped from the storage tank through a series of filters 26, which may be any appropriate type of filter. Automatic self cleaning filters may be used. The filtered combined gel product is metered 27 to the extruder 28 to form the collagen casing. The extruder is preferably a disk extruder. At the extruder, the gel is typically extruded to a thickness from 0.075 to 1.2 thousands, formed, and inflated pneumatically to the desired diameter, typically about 13-34 mm.

Following extrusion, the collagen casing is treated with anhydrous ammonia in the neutralizing section 29. The ammonia reacts with and neutralizes the HCl in the product and causes coagulation of the collagen.

The neutralized collagen casing is washed in a fresh water bath 30 to remove ammonia salts. The washed collagen casing then travels through a series of baskets 31 containing the plasticizer. The plasticizer solution is an aqueous solution containing about 2% to 6% glycerin, about 0.20% to 1.6% sodium carboxymethylcellulose or sodium alginiate, and about 0 to 20 ppm sodium hypochlorite. This process dehydrates the casing for drying purposes and allows introduction of glycerin for elasticity purposes.

The collagen casing travels through a dryer 32, which uses dry heat up to 205° F. The dryer may have multiple stages at different temperatures. After drying, the collagen casing is sent through a humidification chamber (not shown) at approximately 85% relative humidity.

The collagen casing is collapsed and wound on a reel 33. The reeled collagen casing is run through a second humidification chamber where final moisture is added to the casing. The casing is then sent for finishing and shipment.

During the finishing process, moisture is added back to the casing by humidification 34. Then the product is shirred 36 to its specified length and placed in boxes that are over wrapped and vacuum packed 37.

The finished collagen casings are then boxed into FDA approved cardboard boxes 38, which are labeled, bar coded and scanned into the company's lot control system for traceability purposes. The ventilated boxes of slugs may then be placed in a humidification chamber, where forced humidified air is used to bring the moisture content of the product within specifications. As will be recognized by those of ordinary skill in the pertinent art based on the teachings herein, numerous changes and modifications may be made to the above-described and other embodiments of the invention without departing from its scope. For example, one skilled in the art will recognize that multiple extrusion preparation lines and multiple storage tanks for the gel product may be used to ensure a constant supply to the continuous extrusion line. Accordingly, this detailed description of preferred embodiments is to be taken in an illustrative as opposed to a limiting sense.

We claim:

1. A casing for foodstuffs comprising:
(a) a natural gut tissue selected from the group consisting of bovine gut, porcine gut, sheep gut, or combinations thereof; and
(b) edible collagen.

2. The casing of claim 1, wherein the casing comprises between about 1% to about 10% (dry basis) of natural gut tissue.

3. The casing of claim 1, wherein the casing comprises between about 1% to about 7% (dry basis) of natural gut tissue.

4. The casing of claim 1, wherein the casing comprises between about 2% to about 5% (dry basis) of natural gut tissue.

5. The casing of claim 1, wherein the casing comprises between about 5% to about 10% (dry basis) of natural gut tissue.

6. A method for producing a casing for foodstuffs comprising the steps of:
(a) treating bovine corium to produce a buffered corium material;
(b) grinding the corium material to produce a quarter grind corium;
(c) combining the quarter grind corium with a dispersion of acid and cellulose in water;
(d) grinding a natural gut tissue selected from the group consisting of bovine gut, porcine gut, sheep gut, and combinations thereof;
(e) washing the natural gut tissue;
(f) blending the washed natural gut tissue with the quarter grind corium material and acid and cellulose dispersion to produce a gel comprised of natural gut tissue and corium;
(g) extruding the gel and treating the extruded gel to coagulate the gel and form a tubular casing.

7. The method of claim 6, wherein the blend of natural gut tissue and quarter grind corium in the acid and cellulose dispersion comprises between about 3 wt % to about 10 wt % of natural gut tissue and corium, between 0 wt % and about 2 wt % cellulose, between about 0.2 wt % and about 0.3 wt % hydrochloric acid, and the balance is water.

8. The method of claim 7, wherein the natural gut tissue and corium in the blend comprises between about 1% to about 10% of natural gut tissue.

9. The method of claim 7, wherein the natural gut tissue and corium in the blend comprises between about 2% to about 5% of natural gut tissue.

10. The method of claim 7, wherein the natural gut tissue and corium in the blend comprises between about 5% to about 10% of natural gut tissue.

11. A method for producing a casing for foodstuffs comprising the steps of:
(a) treating bovine corium to produce a buffered corium material;
(b) grinding the corium material to produce a quarter grind corium;
(c) combining the quarter grind corium with a dispersion of acid and cellulose in water to produce a corium gel;
(d) grinding a natural gut tissue selected from the group consisting of bovine gut, porcine gut, sheep gut, and combinations thereof;
(e) washing the natural gut material;
(f) combining the natural gut tissue with a hydrochloric acid solution to produce a gel;
(g) combining the corium gel and the natural gut tissue gel; and
(h) extruding the gel and treating the extruded gel to coagulate the gel and form a tubular casing.

12. The method of claim 11, wherein the natural gut tissue and corium in the blend comprises between about 1% to about 10% of natural gut tissue.

13. The method of claim 11, wherein the natural gut tissue and corium in the blend comprises between about 2% to about 5% of natural gut tissue.

14. The method of claim 11, wherein the natural gut tissue and corium in the blend comprises between about 5% to about 10% of natural gut tissue.
